(19) United States
(12) Patent Application Publication
(10) Pub. No.: US 2015/0305586 A1
(43) Pub. Date: Oct. 29, 2015

(54) CLEANING PAD

(71) Applicant: American Covers, Inc., Draper, UT (US)

(72) Inventor: Michael J. Musso, Alpharetta, GA (US)

(21) Appl. No.: 14/694,013

(22) Filed: Apr. 23, 2015

Related U.S. Application Data
(60) Provisional application No. 61/984,442, filed on Apr. 25, 2014.

(51) Int. Cl. A47L 13/16; B05D 1/02; B65D 85/62; A47L 13/17; B65D 43/02

(52) U.S. Cl. CPC A47L 13/16; A47L 13/17; B65D 43/02; B65D 85/62; B05D 1/02

(57) ABSTRACT

An applicator, such as a pad, that includes an absorbent material to absorb an agent on at least a top surface of the pad. The pad allows a user to apply the agent to a surface of an object. The pad can be packaged in a resealable container or sealed in a one-time use package.

### PRIORITY

This application claims priority to U.S. Provisional Patent Application No. 61/984,442, entitled “Leather Cleaning Pad,” filed on Apr. 25, 2014, the disclosure of which is incorporated by reference herein.

### BACKGROUND

Dispensable cleaning products that are pre-moistened with a cleaning and/or a conditioning agent, such as wipes, are known in the art. These dispensable cleaning products may be used to clean and/or condition a variety of products, including leather products such as auto upholstery, saddlery, boots, briefcases, luggage, sports equipment, shoes, furniture, handbags, etc. Other types of products may include vinyl, rubber, and/or plastic surfaces such as dashboards, tires, etc. In some instances, it is desirable for a dispensable cleaning product to be more durable to provide an easier application of the cleaning and/or conditioning agent. A more durable cleaning product may also prevent or minimize the cleaning product from ripping or breaking during application of the cleaning and/or conditioning agent. As such, there is a need for improved cleaning products that are more durable.

### BRIEF DESCRIPTION OF THE DRAWINGS

While the specification concludes with claims which particularly point out and distinctly claim the invention, it is believed the present invention will be better understood from the following description of certain embodiments taken in conjunction with the accompanying drawings, in which like reference numerals identify the same elements.

FIG. 1 depicts a top perspective view of a cleaning pad.

FIG. 2 depicts a side elevational view of the cleaning pad of FIG. 1.

FIG. 3 depicts a side elevational view of a product being applied to the cleaning pad of FIG. 1.

FIG. 4 depicts a side elevational view a package for storing the cleaning pad of FIG. 1.

FIG. 5 depicts a top perspective view of the package of FIG. 4, showing a lid of the package removed to expose the cleaning pad of FIG. 1.

FIG. 6 depicts a side elevational view of an alternative package for storing the cleaning pad of FIG. 1.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain embodiments of the present disclosure should not be used to limit the scope of the present disclosure. Other examples, features, aspects, embodiments, and advantages of the invention will become apparent to those skilled in the art from the following description. As will be realized, various aspects of the present disclosure may take alternate forms, or have alternate or additional embodiments, without departing from the scope of the present disclosure. Accordingly, the drawings and descriptions should be regarded as illustrative in nature and not restrictive.

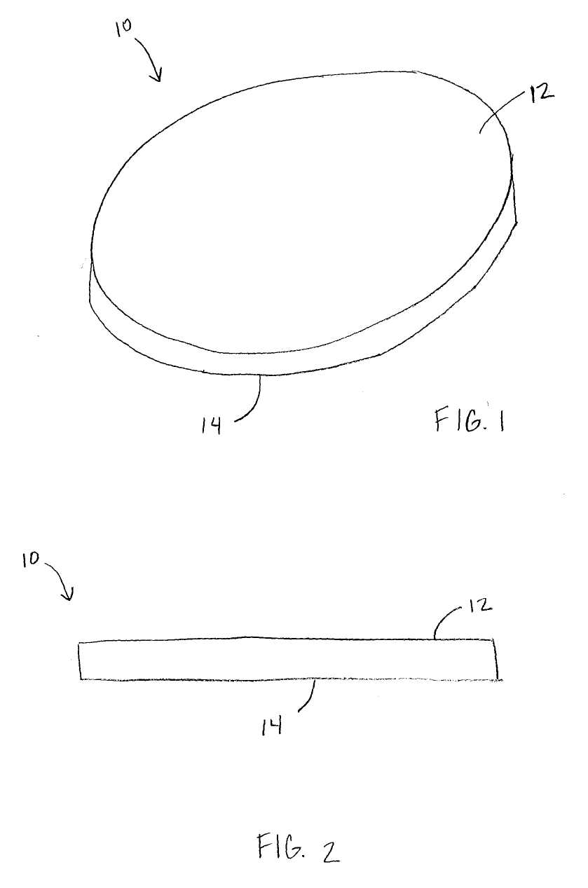

FIGS. 1 and 2 show a cleaning pad (10) for applying an agent to a surface of an object. The agent can be applied to help clean, condition, and/or preserve the surface of the object. As best seen in FIG. 1, cleaning pad (10) comprises a circular shape having a top surface (12) and a bottom surface (14). Cleaning pad (10) can comprise other suitable shapes, such as a square, rectangle, triangle, octagon, hexagon, etc. In the present embodiment, cleaning pad (10) has a diameter of about 4 inches. The diameter of cleaning pad (10) can have a smaller or larger diameter in other embodiments such that the size of cleaning pad (10) is sufficient to apply a cleaning and/or conditioning agent to an object.

Cleaning pad (10) comprises an absorbent material, such as non-woven cotton, to sufficiently absorb the agent for later application to an object. Other suitable materials will be apparent to one with ordinary skill in the art in view of the teachings herein. The cleaning pad (10) of the present embodiment also has a density of between about 300 grams per square meter (gsm) and about 400 gsm, such as about 300 gsm. Of course other suitable densities will be apparent to one of ordinary skill in the art in view of the teachings herein. Accordingly, cleaning pad (10) is more durable, such as with respect to wipes.

As described above, the agent applied to cleaning pad (10) can be an agent for leather products, such as auto upholstery, saddler, boots, briefcases, luggage, sports equipment, shoes, furniture, handbags, etc. For instance, the agent may be a cleaning and conditioning agent to clean, restore, and preserve leather, such as Lexol 3-in-1 formula cleaner available from Summit Industries, Inc. Other suitable agents may also be applied to cleaning pad (10), such as agents that can help clean, condition, and protect vinyl surfaces, rubber surfaces, plastic surfaces, etc.

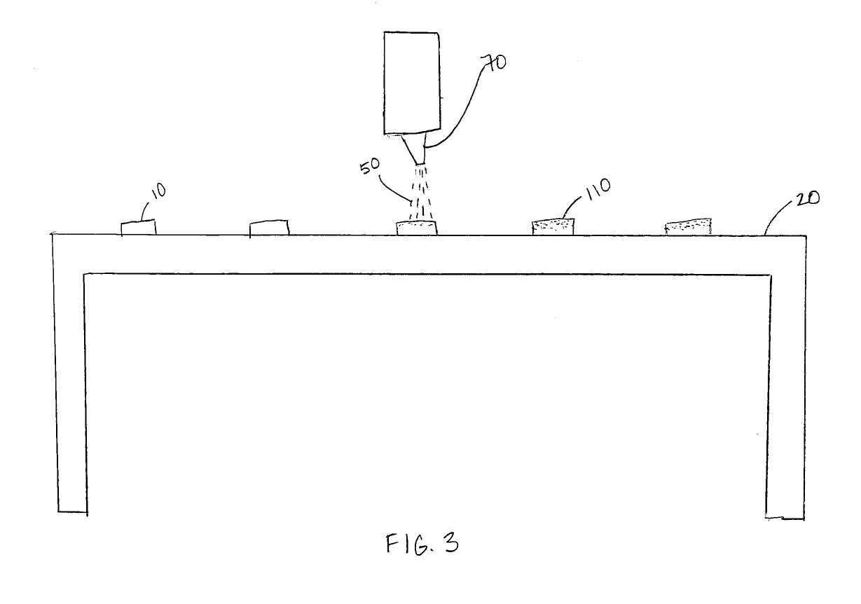

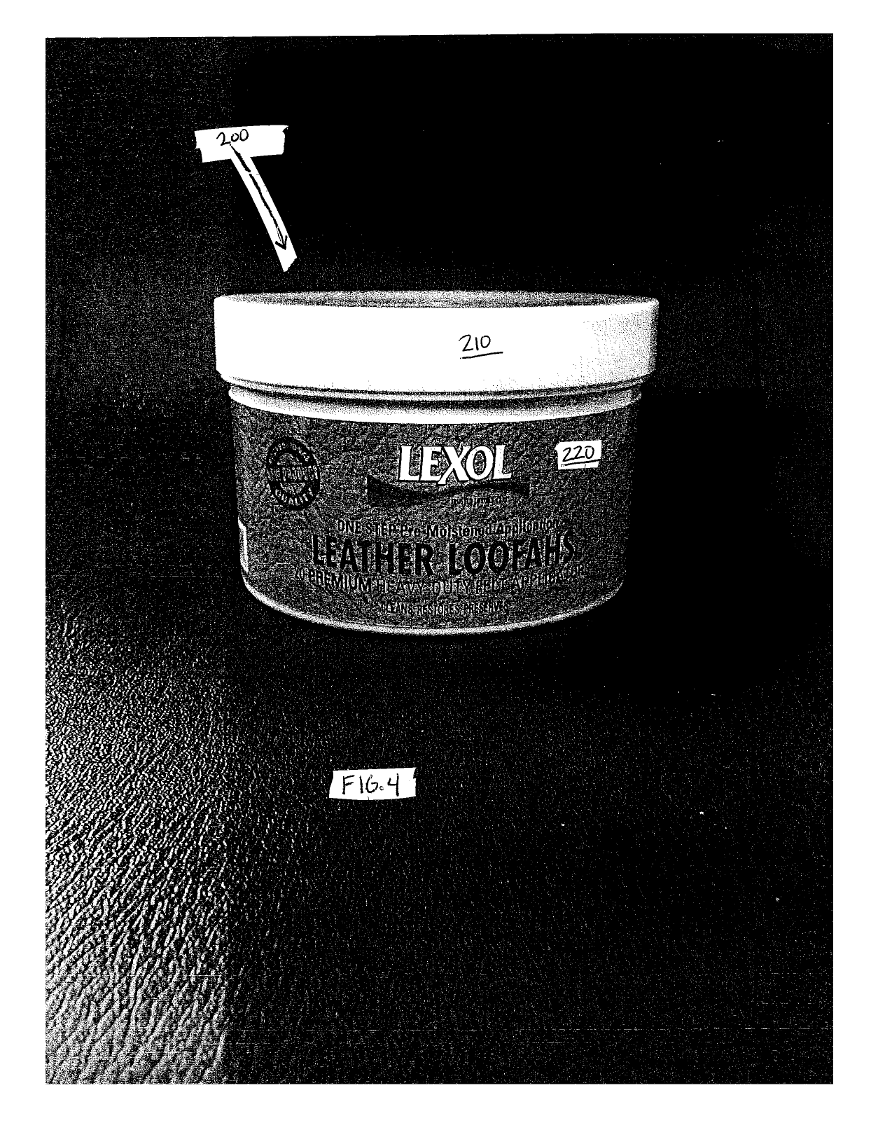

FIG. 3 shows an agent (50) being applied to cleaning pad (10). In the illustrated embodiment, cleaning pad (10) is placed on a conveyor (20). As cleaning pad (10) is transported along conveyor (20), cleaning pad (10) travels under nozzle (70) and nozzle (70) sprays cleaning pad (10) with agent (50). Agent (50) then soaks into cleaning pad (10) to form a saturated cleaning pad (110). While FIG. 3 shows cleaning pad (110) being saturated with agent (50) on a top surface of cleaning pad (110), cleaning pad (110) can be flipped and sprayed again by nozzle (70) to thereby saturate the opposing side of cleaning pad (110) with agent (50). Cleaning pad (110) of the present embodiment is saturated with about 11.5 grams of agent (50), although other suitable amounts of agent (50) can be applied.

Other suitable methods of applying agent (50) to cleaning pad (10) may be used.

For instance, cleaning (10) may be dunked or immersed in agent (50). Because merely dunking cleaning pad (10) in agent (50) may not allow agent (50) to fully absorb into cleaning pad (10), cleaning pad (10) may need to be rolled or wrung out to allow agent (50) to saturate cleaning pad (10).

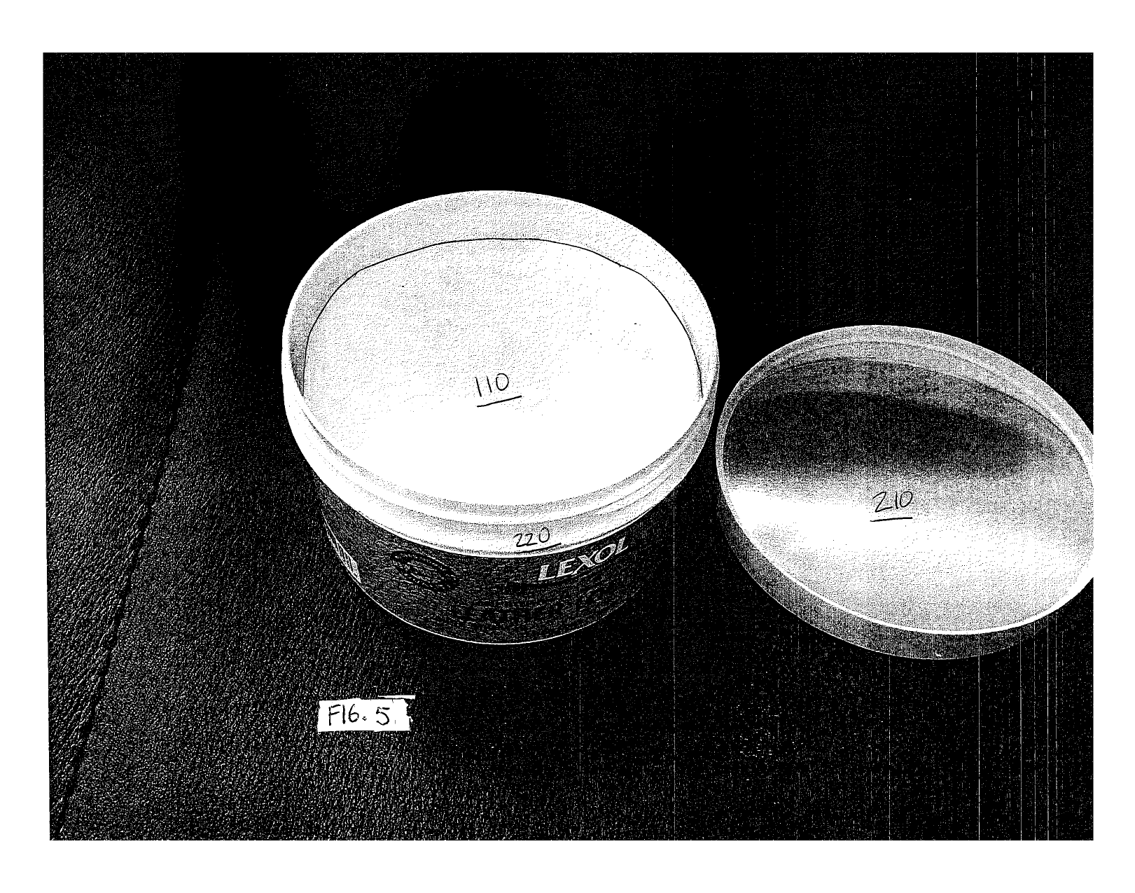

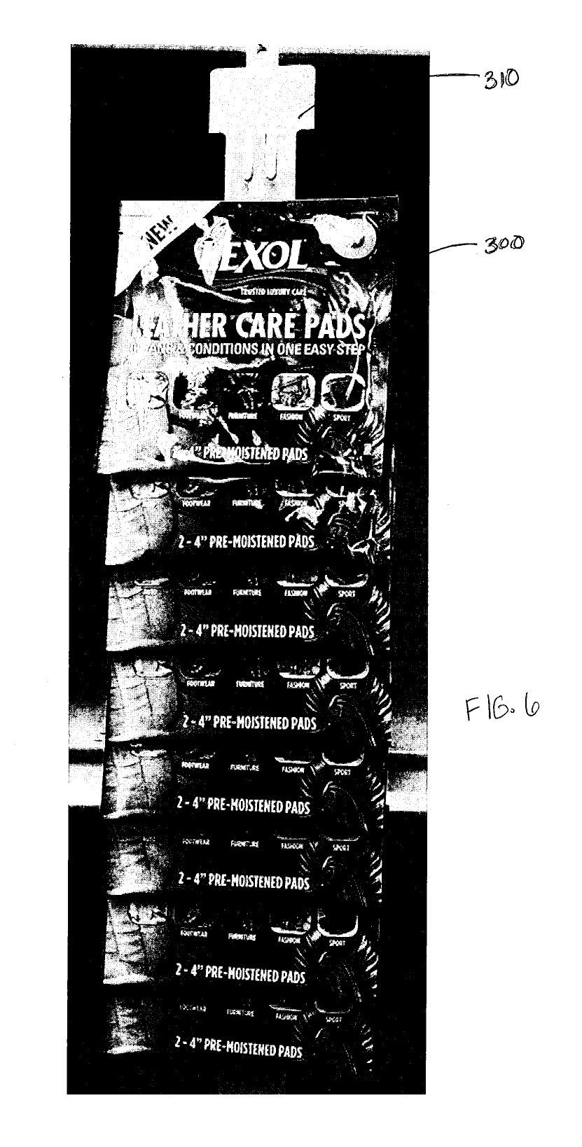

Once cleaning pad (110) is saturated by agent (50), the pre-moistened cleaning pad (110) may be packaged for later use by a consumer. FIGS. 4 and 5 show a first embodiment of a package (200) comprising a container (220) and a removable lid (210). As best seen in FIG. 5, saturated cleaning pads (110) are placed or stacked within container (220). For instance, about twenty cleaning pads (110) are stacked within a 24 ounce container (220), but other suitable amounts can be used. Lid (210) is then coupled to container (220), as shown in FIG. 4, to retain the moisture within cleaning pads (110). Lid (210) may be coupled to container (220) by threads, a friction fit, or any other suitable method.

A user can then remove lid (210) from container (220) to receive a pre-moistened cleaning pad (110) from package (200) for application to a leather surface. For instance, the user can apply agent (50) evenly across a leather surface using cleaning pad (110). After a few minutes, the user can then wipe any excess agent (50) from the leather surface and buff the surface clean with a cloth. Cleaning pad (110) can then be disposed or reused on another surface. The user can replace lid (210) on container (220) to retain the moisture within the remaining cleaning pads (110) for later use. Cleaning pad (110) can also be used to clean and/or condition other types of surfaces, such as vinyl, rubber, and/or plastic surfaces.

FIG. 6 shows another embodiment of a package (300) for a one time application.

As shown, package (300) comprises a sealed package containing two pre-moistened cleaning pads (110). Package (300) can be ripped open to provide a user with cleaning pads (110). Because package (300) cannot be resealed, package (300) is for a one-time use application of cleaning pads (110). While FIG. 6 shows package (300) containing two cleaning pads (110), any other suitable amount of cleaning pads (110) can be used as will be apparent to one with ordinary skill in the art in view of the teachings herein. FIG. 6 further shows packages (300) hung from a clip strip (310) for display of packages (300).

It should be understood that any one or more of the teachings, expressions, embodiments, examples, etc. disclosed herein may be combined with any one or more of the other teachings, expressions, embodiments, examples, etc. that are disclosed herein. The teachings, expressions, embodiments, examples, etc. disclosed herein should therefore not be viewed in isolation relative to each other. Various suitable ways in which numerous aspects of the present disclosure may be combined will be readily apparent to those of ordinary skill in the art in view of the teachings disclosed herein. Such modifications and variations are intended to be included within the scope of both the present disclosure and the claims.

Having shown and described various embodiments of the present disclosure, further adaptations of the methods and systems described herein may be accomplished by appropriate modifications by one of ordinary skill in the art without departing from the scope of the present disclosure. Several of such potential modifications have been mentioned, and others will be apparent to those skilled in the art. For instance, examples, embodiments, geometrics, materials, dimensions, ratios, steps, and the like discussed above are illustrative and are not required. Accordingly, the scope of the present disclosure should be considered in terms of the following claims and is understood not to be limited to the details of structure and operation shown and described in the specification and drawings.

What is claimed is:

1. An applicator for applying an agent comprising a pad, wherein the pad comprises an absorbent material configured to absorb the agent on at least a top surface of the pad, wherein the pad is configured to apply the agent to a surface of an object.

2. The applicator of claim 1, wherein the pad is saturated with the agent on an opposing bottom surface of the pad.

3. The applicator of claim 1, wherein the pad is circular.

4. The applicator of claim 1, wherein the pad comprises non-woven cotton.

5. The applicator of claim 4, wherein the pad comprises a density of about 300 to about 400 grams per square meter.

6. The applicator of claim 1, wherein the pad comprises about 11.5 grams of the agent.

7. The applicator of claim 1, wherein the pad is configured to receive the agent by a spray.

8. The applicator of claim 1, wherein a plurality of the pads are configured to be stacked within a package comprising a container and a lid.

9. The applicator of claim 1, wherein at least one pad is configured to be packaged in a sealed package for a one-time use application.

10. The applicator of claim 1, wherein the agent is operable to clean, condition, and preserve the surface of the object.

11. The applicator of claim 1, wherein the pad is operable to apply the agent to a leather surface.

12. A method for making an applicator for applying an agent to a surface of an object, wherein the applicator comprises a pad, the method comprises spraying the agent onto a first surface of the pad using a nozzle.

13. The method of claim 12, further comprising transporting the pad along a conveyor to position the pad underneath the nozzle.

14. The method of claim 12, further comprising flipping the pad and spraying the agent onto an opposing, second surface of the pad using a nozzle.

15. The method of claim 12, further comprising packaging the pad.

16. The method of claim 15, further comprising stacking a plurality of the pads into a package comprising a container and coupling a lid to the container to retain the moisture of the pads.

17. The method of claim 15, further comprising sealing at least one pad in a package for a one-time use application.

18. The method of claim 17, further comprising aligning a plurality of the sealed packages on a clip strip to display the sealed packages.

19. The method of claim 12, further comprising applying the agent to a leather surface using the pad.

20. A package comprising:
an applicator for applying an agent comprising a pad, wherein the pad comprises an absorbent material configured to absorb the agent on at least a top surface of the pad, wherein the pad is configured to apply the agent to a surface of an object;
a package comprising a container, wherein the container is configured to receive a plurality of the pads in a stacked configuration; and
a lid selectively couplable with the container, wherein the lid is configured to retain the moisture of the pads.
